(19) United States
(12) Patent Application Publication
(10) Pub. No.: US 2016/0001735 A1
(43) Pub. Date: Jan. 7, 2016

(54) TUBULAR AIRBAG

(71) Applicant: Zodiac Seats France, Issoudun (FR)

(72) Inventors: Frederic Quatanens, Issoudun (FR); Jeremy Cailleteau, Saint Aout (FR); Jean-Marc Obadia, L'Isle d'Abeau (FR)

(73) Assignee: Zodiac Seats France, Issoudun (FR)

(21) Appl. No.: 14/854,605

(22) Filed: Sep. 15, 2015

Related U.S. Application Data
(63) Continuation-in-part of application No. 13/428,100, filed on Mar. 23, 2012.
(60) Provisional application No. 61/545,641, filed on Oct. 11, 2011.

(51) Int. Cl. B60R 21/233; B60R 21/207; B64D 11/06; B60R 21/26

(52) U.S. Cl. CPC B60R 21/233; B60R 21/26; B60R 21/207; B64D 11/06205; B60R 2021/23107

(57) ABSTRACT

Embodiments of the present invention provide an airbag system formed of a plurality of tubular structures.

### CROSS REFERENCE TO RELATED APPLICATIONS

This application claims the benefit of and is a continuation-in-part of U.S. Ser. No. 13/428,100, filed Mar. 23, 2012, titled “Tubular Airbag,” which application claims the benefit of U.S. Provisional Application Ser. No. 61/545,641, filed Oct. 11, 2011, titled “Tubular Airbag,” the entire contents of which are hereby incorporated by reference.

### FIELD OF THE INVENTION

Embodiments of the present invention relate generally to airbags for use in passenger transport vehicles. The airbags are designed to safely interrupt a passenger's forward momentum in the event of a crash condition.

### BACKGROUND

Airbags are occupant restraining devices, which typically include a flexible envelope or “bag” that is designed to inflate rapidly during a collision in order to prevent the vehicle's occupants from striking interior objects located in front of (or, in some cases, on the side of) the occupant. In automobiles, airbags are designed to prevent occupants from striking the steering wheel, the vehicle door, a window, or any other interior objects. In aircraft, airbags are designed to prevent passengers from striking the seat in front each passenger, the tray tables, a window, or any other interior objects. Airbags on passenger rail cars (such as trains, monorails, trolleys), motorcycles, and other passenger transport vehicles work similarly.

Most modern vehicles contain multiple airbags. For example, most automobiles provide an airbag in front of each occupant seating position (at least in the front seat), to protect the head and torso. They may also contain knee airbags, which protect the occupant's knees and legs. Most aircraft provide airbags either positioned in the back of each seat (so as to deploy for the passenger sitting behind that seat) or in the seat belts. (For example, passengers sitting in the front seat or bulkhead in the aircraft do not have a seat in front of them, so in this instance, the airbag may be positioned in the passenger seat belt.) Passenger vehicles may also contain airbags in side locations, which can inflate between an occupant and the vehicle door or the vehicle window or wall.

Typically, sensors deploy one or more airbags in an impact zone at variable rates based on the type and severity of impact. Most airbags are designed to only inflate in moderate to severe frontal crashes. Airbags are normally designed with the intention of supplementing the protection of an occupant who is correctly restrained with a seatbelt.

Airbags are typically designed as large bags that require a large volume of gas for their inflation. They are typically round in shape, or peanut shaped, examples of which are shown in prior art FIGS. 33 and 34. They are often formed by sewing two or three panels together in order to form a balloon or peanut shape. An alternate airbag shape that was designed for side-impact head protection in automobiles is the Inflatable Tubular Structure (ITS) airbag. This system is a single inflatable tube that stows in the vehicle's interior roof-rail. During a crash, the ITS deploys across the side windows to offer a cushioning restraint for the vehicle occupants.

Since their invention in the early 1950's and introduction in the mid-1970's, airbags have continually been improved upon. However, further airbag improvements are desirable, including airbags that have varying designs for varying types of seating arrangements in passenger vehicles.

### BRIEF SUMMARY

Embodiments of the invention described herein thus provide airbags that are designed to use a lower inflation volume than traditional airbags. In one embodiment, this is accomplished by providing a plurality of tubular airbags secured to one another.

### BRIEF DESCRIPTION OF THE DRAWINGS

FIG. 1 shows a vehicle occupant being braced by a tubular airbag expanding from a rear of a monument or a passenger seat privacy shell.

FIG. 2 shows a side perspective view of a tubular airbag according to one embodiment of this invention.

FIG. 3 shows a top plan cross-sectional view of the top layer of airbag of FIG. 2.

FIG. 4 a top plan cross-sectional view of an airbag having four tubular structures, before the tubular structures are stacked or otherwise secured.

FIG. 5 shows a side view schematic of a tubular airbag having tubular structures with a circular cross-section.

FIG. 6 shows a top plan view of one embodiment of a tubular airbag with a cushion.

FIG. 7 shows a top perspective view of one embodiment of a tubular airbag with a cushion.

FIG. 8 shows a top plan view of one embodiment of a tubular airbag with a cushion.

FIG. 9 shows a crash sequence and the deployment of a tubular airbag.

FIG. 10 shows a side perspective view of an alternate tubular airbag.

FIG. 11 shows a side plan view of the airbag of FIG. 10.

FIG. 12 shows a top plan cross-sectional view of the upper layer of the airbag of FIGS. 10 and 11, before the tubular structures are stacked or otherwise secured.

FIG. 13 shows a side view of a crash sequence and the deployment of a tubular airbag of FIGS. 10 and 11.

FIG. 14 shows a top view of a crash sequence and the deployment of a tubular airbag of FIGS. 10 and 11.

FIG. 15 shows various sewing and folding configurations for tubular airbags.

FIG. 16 shows an end plan view of a set of tubular airbags, with a secured junction between the top layer of tubes and the lower layer of tubes.

FIG. 17A shows an end plan view of a set of tubular airbags, without a secured junction between the top layer of tubes and the lower layer of tubes, but with a side strap in place.

FIG. 17B shows a side perspective view of a tubular airbag system having an upper layer and lower layer secured by a lateral side strap.

FIG. 18 shows one particular folding sequence for the tubular airbags.

FIG. 19 shows one example of a tubular airbag system having a curved surface at the securement point to an aircraft structure.

FIG. 20A shows a side plan view illustrating air moving between an upper layer of one or more tubes and a lower layer of one or more tubes.

FIG. 20B is a cross-sectional view of FIG. 20A along lines B.

FIG. 21 is a side plan view illustrating air moving between an upper layer of one or more tubes and a lower layer of one or more tubes, illustrating inflow passages into the tubular airbag having varying dimensions.

FIG. 22 shows a front view of an airbag system installed to an aircraft structure via a plate having four fixation points.

FIG. 23 shows a front view of an airbag system installed to an aircraft structure via a plate having three fixation points.

FIG. 24 shows an airbag of FIG. 23 in a folded configuration, prior to installation.

FIG. 25 shows a side perspective view of one embodiment of an airbag system secured with a lateral strap, and having a vent on each of the upper and lower layers.

FIG. 26 shows a side perspective view of one embodiment of an airbag system secured with a lateral strap, and having varying sized vents.

FIG. 27 shows a side perspective view of a tubular airbag system having a longer upper layer than the lower layer.

FIG. 28A shows a side perspective schematic view of one embodiment having an upper layer made of two side-by-side tubular structures and a lower layer made of a single, larger tubular structure.

FIG. 28B shows a top perspective schematic view of the larger tubular structure of FIG. 28A.

FIG. 29A shows a side schematic view of one embodiment having an upper layer made of a single, larger tubular structure and a lower layer made of two side-by-side tubular structures.

FIG. 29B shows a top perspective schematic view of the larger tubular structure of FIG. 29A.

FIG. 30 shows a side perspective schematic view of an alternate tubular structure configuration.

FIG. 31 shows a side perspective schematic view of a further alternate tubular structure configuration.

FIG. 32 shows a top perspective view of a tubular airbag system oriented at an angle from an aircraft structure.

FIG. 33 shows a prior art airbag having a spherical balloon shape.

FIG. 34 shows a prior art airbag having a peanut balloon shape.

### DETAILED DESCRIPTION

Rather than requiring a large volume of gas to fill a large round airbag, it is desirable to design an airbag that reduces the global inflated volume of the airbag. This can require less gas to inflate the bag, allowing the bag to fill more quickly and efficiently. It can also reduce the overall weight of the total airbag system, by allowing use of a smaller inflator. It is also desirable to design airbags having varying shapes, and particularly, shapes that cause the airbag's inflated position to be closer to the occupant. This can improve performance of the airbag (as measured by head injury criteria) by causing the bag to be in earlier contact with the vehicle occupant. It is also desirable to provide an airbag that has a shape and design that allows it to be easier to produce and fold. These and other advantages are achieved by the tubular airbags of embodiments of the present invention. The airbags are provided as inflatable cushions that are made of a tubular shape and oriented in a particular configuration. In a specific embodiment, multiple tubular structures are positioned in a generally parallel configuration to one another.

Accordingly, embodiments of the present invention provide an airbag that has one or more tubular structures. The airbag may be associated with a seat back, a privacy shell, a monument, or any other aircraft structure, such that the airbag deploys backward to support a passenger in a seat behind. Alternatively, it may be associated with a steering wheel, a side wall of a vehicle, or any other vehicle structure.

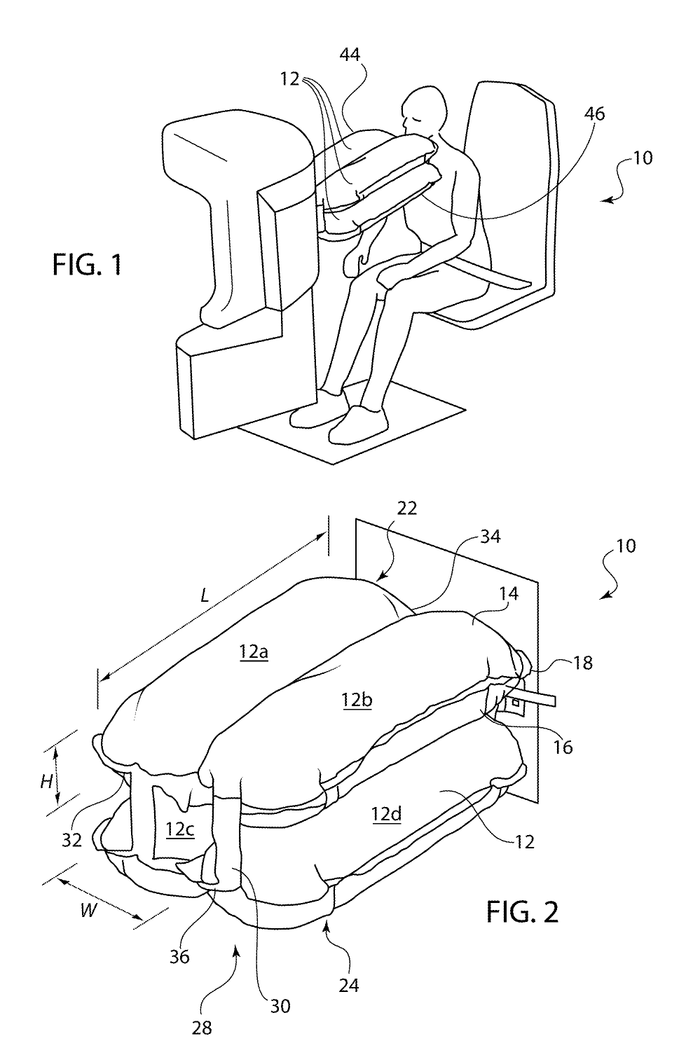

One embodiment of a tubular airbag system 10 is shown in FIGS. 1 and 2. Airbag 10 is formed from a series of tubular structures 12. Tubular structures 12 may be formed as individual tubes. Tubular structures 12 may be formed such that they are fluidly communicable with one another. In one example, two tubular structures 12 may form an upper layer 44, and two tubular structures 12 may form a lower layer 46. The tubular structures 12 may be fabric tubes, pliable plastic tubes, or any other appropriate material that can be inflated to hold a volume of gas. Each tubular structure 12 generally has a length L, a width W, and a height H. The length dimension “L” is greater than the width “W” or the height “H” dimension. In a particular embodiment, tubular structures 12 may be formed from top 14 and bottom 16 sheets of material, joined at a seam 18 that extends generally around the perimeter of the structure 12, as is shown in FIG. 2. Joining may be accomplished by stitching, bonding, gluing, or any other appropriate securing or sealing option. However, it should be understood that tubular structures 12 may be otherwise formed. For example, a single sheet of material may have its edges sewn or glued together in order to create a single seam on one side, with one (or both) ends sewn or glued together (or overlapped and secured) in order to close the end of tube. As another example, the tubular structures 12 may be individually formed and secured to one another.

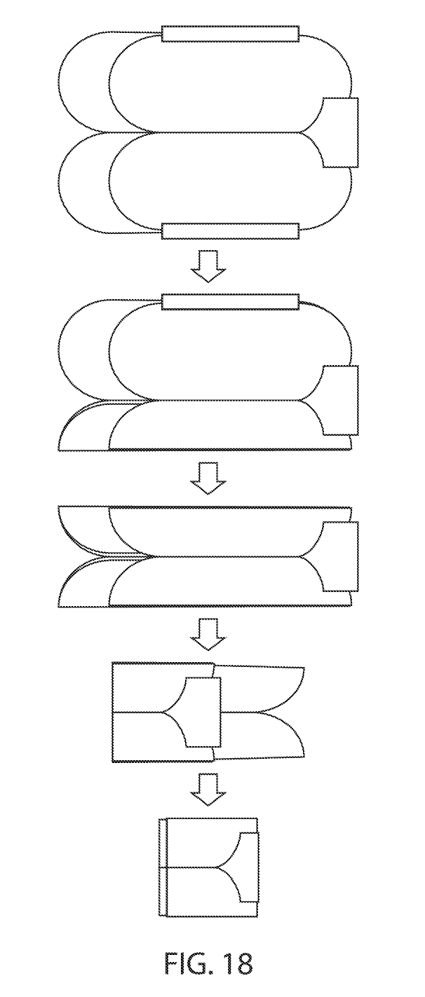

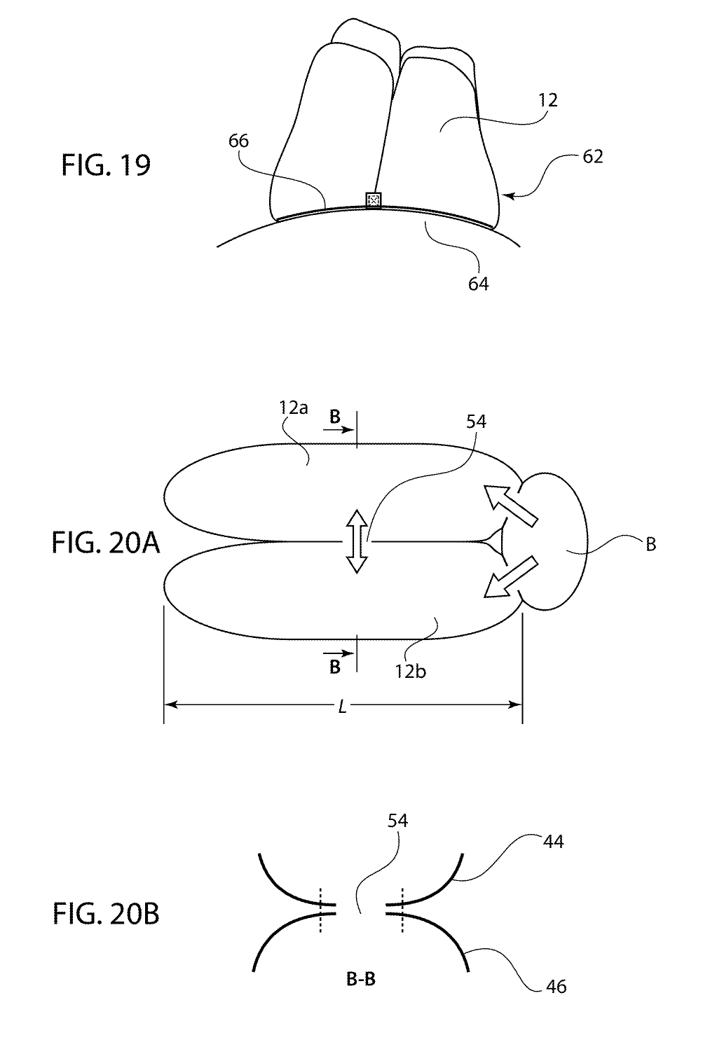

The tubular structures 12 are shown in FIGS. 1-14 as having a generally rounded top surface 22 and a rounded bottom surface 24 such that they have an oval-like or circular cross section 26. It should be understood, however, that tubular structures 12 may be formed as having a square, rectangular, triangular, trapezoidal, conical, or round or other cross section. For example, as illustrated by FIG. 19, it is possible for the structure 12 to have a trapezoidal or conical shape 60 at its monument-facing end 62. Structures 12 having varied shapes may assist with securement of the structures 12 to the aircraft structure. For example, some privacy shells or monuments may have a curved surface 64. Providing a structure 12 having a similarly curved or angled connection face 66 may allow the structure 12 to make better contact with the privacy shell or monument surface 64. The angled or conical shape may be provided at the end where the airbag is to be secured. The angled or conical shape is provided by the original shape of the cut panel, such that the end has a varied shape.

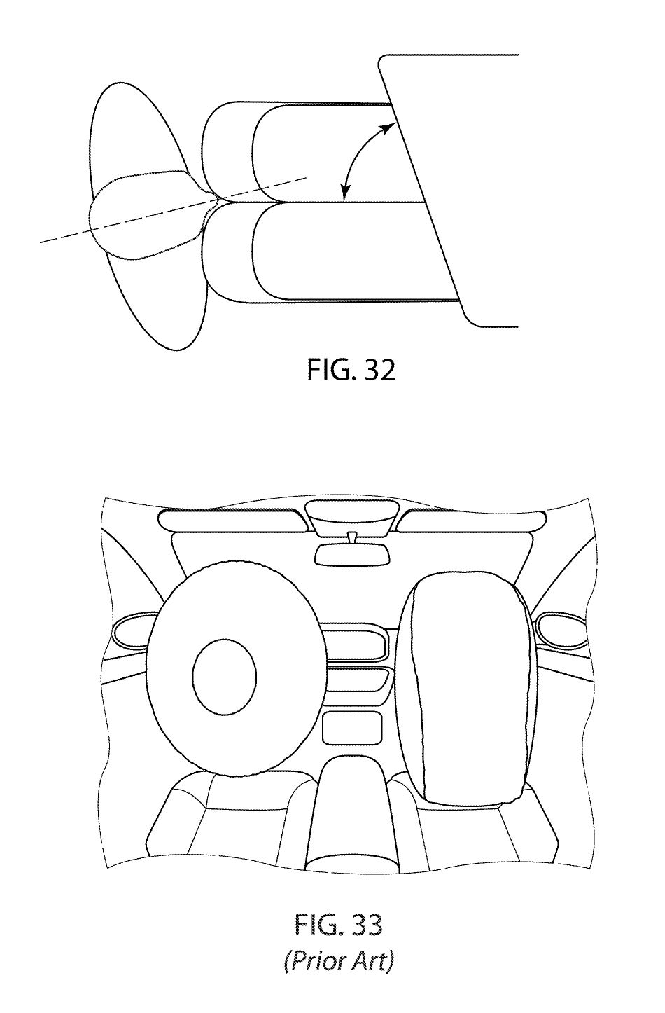

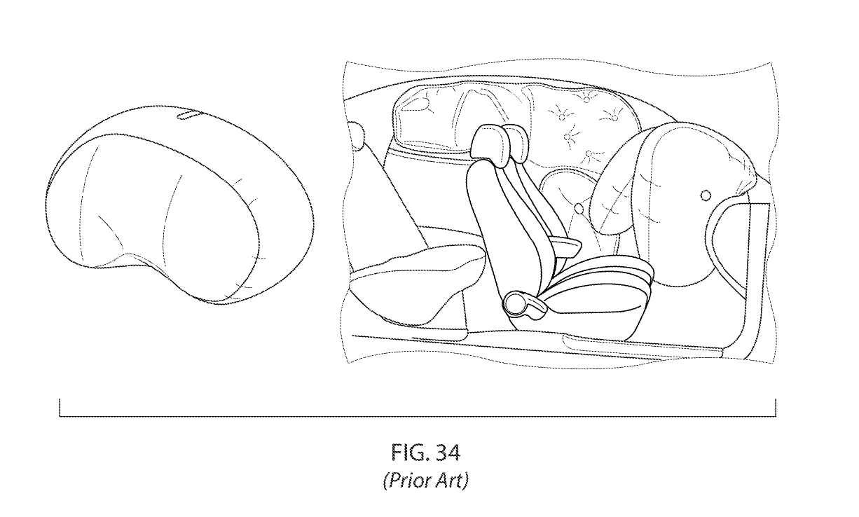

In another example, FIG. 32 illustrates tubular structures oriented at an angle in order to compensate for the angle that can form between the monument, privacy shell, cabinet, or other aircraft structure from which the airbag system extends with respect to the occupant. This can help align the tubular structures in the path of the occupant. The angled face of the airbag structure may be provided by cutting and sewing the panels into the desired shape. The shape may be cut near an end where the airbag is to be secured and maintained in place with respect to the aircraft structure. In one example, the angled connection face 66 may be provided on the inflation bag B. This can allow the tubular structures to extend away from a structure that is angled with respect to the passenger seat positioned behind, compensating for the angle between the structure and the passenger seat.

The term “tubular” as used herein is not intended to be restrictive to a particular shape, but is instead intended to refer to a generally elongated tube-like structure that has a hollow interior that can accept a volume of inflation gas. The structure may be any shape, as long as it has a length that is greater than either its width or its height, and has an interior hollow area to accept inflation gas. FIG. 5 illustrates an embodiment wherein the tubular structures are formed as structures having a circular cross-section 27, as opposed to an oval cross-section. FIG. 19 illustrates an embodiment where the tubular structures are formed as trapezoidal structures. Other figures illustrate embodiments where the tubular structures are formed as conical structures.

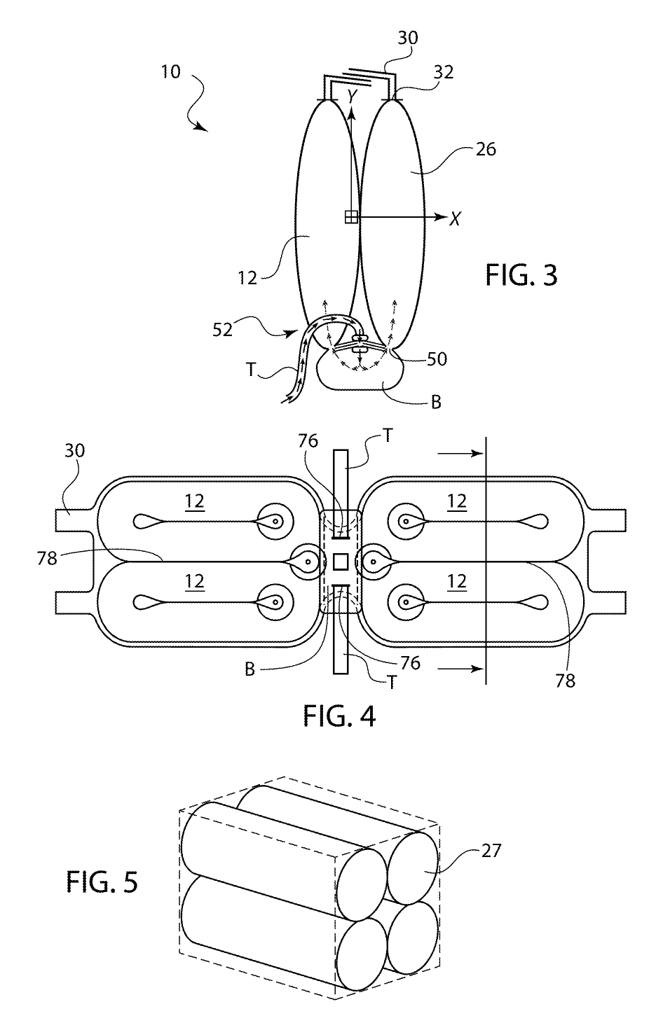

At one end of each structure 12 is an opening 50 for receiving inflation gas. The opening 50 is generally at the tip end 52 of each structure 12. The opening 50 is generally located at the end 52 of the structure 12 where the structure 12 will be secured to the seat, monument, privacy shell, or any other aircraft structure. As shown, the opening 50 may be in fluid communication with a inflation bag B, which is in turn in fluid communication with one or more tubes T to deliver inflation gas. Inflation gas is reflected by dotted lines and arrows in FIG. 3. In use and during a crash condition, inflation gas is immediately and rapidly pumped from the tube T into the bag B and into each opening 50 in each structure 12 in order to cause the airbag system 10 to inflate and cushion an occupant's forward momentum.

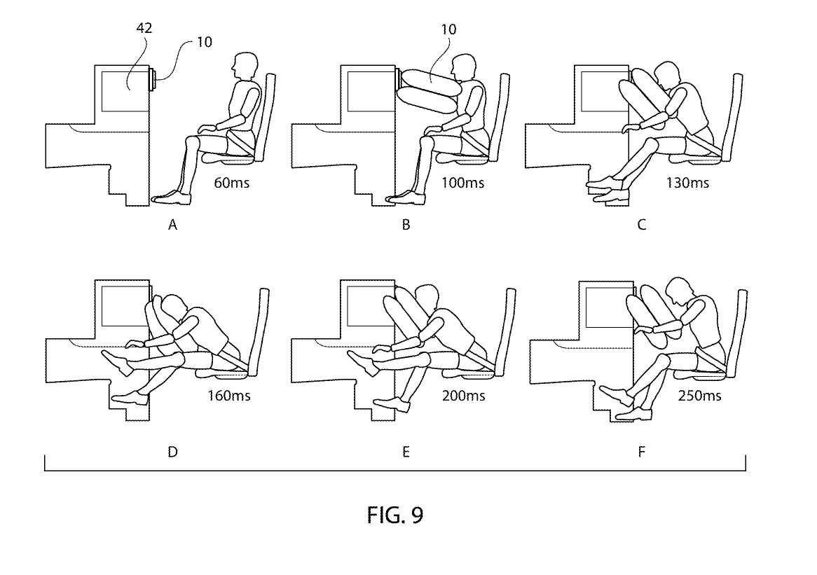

In one specific example shown in FIG. 20A, the structures 12 may be formed so that at least one of the structures 12 is fluidly connected to at least one of the other structures 12. As shown, a fluid passageway 54 may be provided between the tubular structures 12a and 12b. In order to form the passageway 54, it is possible for the layers of material to be sewn only a partial length L of the structures 12a, 12b, leaving a fluid passageway 54 therebetween. Although the passageway 54 is shown generally along the midpoint between the structures 12a, 12b, it should be understood that it may be located anywhere along the structures 12a and 12b. Providing a fluid passageway 54 may help allow faster inflation of the tubular structures 12. It may also help the structures 12 inflate simultaneously. The passageway may be between two (or more) tubular structures of an upper layer, two (or more) tubular structures of a lower layer, or between two (or more) tubular structures of one or more intermediate layers, if provided. If the airbag system 10 is provided with stacked tubular structures 12 as illustrated by FIG. 9, it is possible for additional fluid passageways 54 to be provided between upper and lower tubular structures 12. It is generally believed to be desirable for the lower tubular structures to have a higher pressure than the upper tubular structures in order to provide the desired cushioning effect. The cross-sectional view of FIG. 20B shows a passageway 54 located between an upper layer 44 and a lower layer 46 of tubular structures.

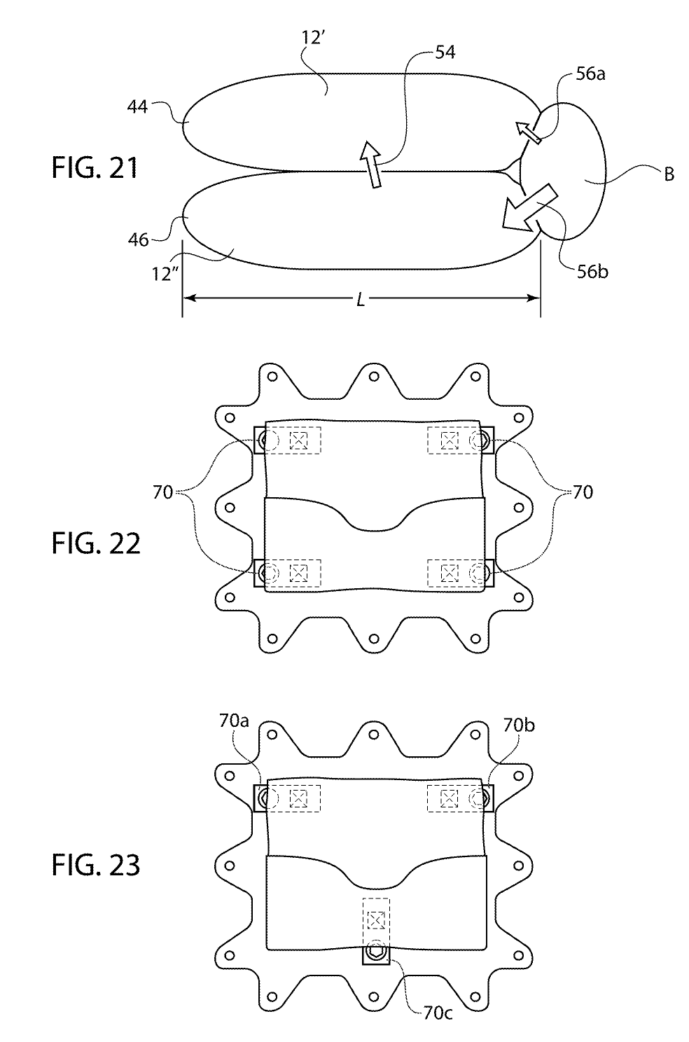

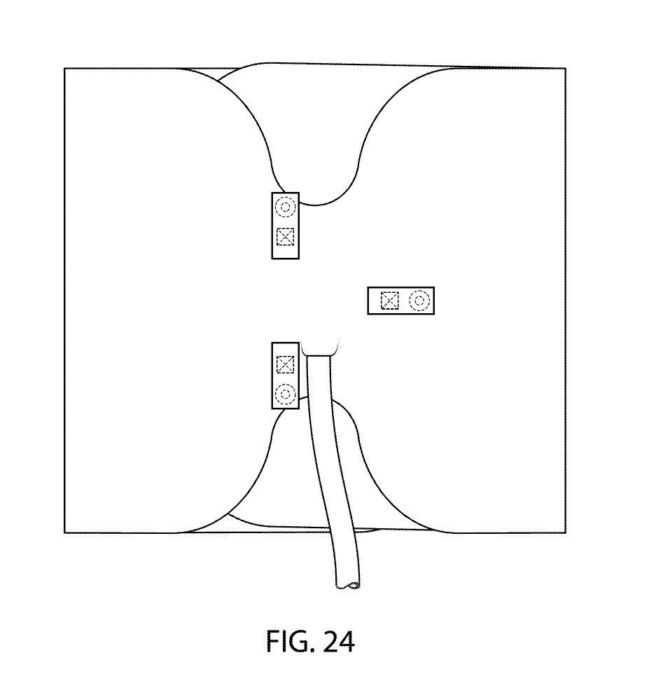

In another example, it may be desirable for one or more of the structures 12 to inflate more quickly than another. FIG. 21 illustrates one embodiment in which the fluid flow from the bag B enters tubular structures 12′ and 12″ at varying flow rates due to differently sized inflow passages 56. As shown, it is possible for one of the inflow passageways 56b between the bag B and the structure 12 to be larger than another. In this example, the inflow passage 56a that delivers inflation gas to the upper layer 44 is smaller than the inflow passage 56b that delivers inflation gas to the lower layer 46. (Although described as being upper and lower layers, it should also be understood that air may be allowed to travel between side-by-side layers as well. For example, the fluid passageway 54 may be positioned between two side-by-side tubular structures of an upper layer and/or between two side-by-side tubular structures of a lower layer.) Fluid inflow passageway 56b is larger than fluid passageway 56a. The effect of this configuration and size difference is that inflation gas is delivered more quickly to the lower layer 46. The second tubular structure 12″ in fluid communication with the larger inflow passageway 56b will inflate more quickly than the first tubular structure 12′ that is in fluid communication with a smaller fluid inflow passageway 56a. Having fluid passageways 56a, 56b of varied dimensions can help manage the sequence of inflation and/or can help manage a pressure differential between the tubes. For example, if structure 12″ inflates first, it will generally be at a higher pressure than structure 12′. This option can help manage the sequence of inflation. Although not shown, it is also possible for the inflow passage 56a to be larger than the inflow passage 56b. It is also understood that passageway 54 shown and described may additionally or alternatively be provided between side-by-side tubular structures of the same layer.

In one example, the airbag system 10 may be secured to the aircraft structure via four fixation points 70, as illustrated by FIG. 22. In another example, it is possible for the airbag system to be secured to the aircraft structure by only three fixation points 70, as illustrated by FIG. 23. In this example, two of the fixation points 70a and 70b may be upper fixation points, but fixation point 70c may be centrally located between the tubular structures 12, such that only a single lower fixation point is necessary.

One of the benefits of designing the airbag 10 as having a plurality of tubular structures 12 that are individually inflated or inflated simultaneously rather than one single large airbag of the prior art is that the tubular airbag 10 requires a lower volume of gas for inflation. Thus, although the bag itself may require more material and may have a greater weight than a traditional airbag, the volume of the inflator gas bottle required to fill the airbag can be smaller, so that the overall system may have a lower global weight. The tubular shape is believed to reduce the stress on the material. Based on the pressure formula [force=pressure/surface], a lighter and thinner material can also be used to create airbag 10. Airbag 10 also requires a smaller volume of gas to inflate than a traditional airbag that is not divided into distinct structures 12, because the use of tubular structures 12 as opposed to a large air bag reduces the total inflated volume of the airbag 10. For example, the volume of gas required to fill a traditional airbag 10 (i.e., one that is not formed by tubular structures 12) is about 20-25% less than the volume required for a traditional air bag having a similar length and width. According to the below calculation, the volume savings is about 22%:

The ratio is the following at iso head injuries performance:

3D bag (which refers to a traditional round airbag) volume is Length×Width×Height so L×W×W when width=height.

By contrast, the tubular airbag structure provides the following volume calculations which compare a parallelepiped-shaped air bag to the tubular airbags described herein:

(with heights equivalent) 4×Length×(Tube diameter×Tube diameter×3.14/4)=As tube diameter is equivalent to half of the Width so 4×L×(W/2×W/2×3.14/4)=L×W×W×3.14/4 so for the same bag behavior in term of protection, there is −22% volume less to inflate (0.785−1*100%) so L×W×W×0.785 (tubular bag volume)<L×W×W (3d bag volume). A schematic of these comparative dimensions is shown in FIG. 5.

The airbag system 10 disclosed also allows for the use of a smaller inflator volume compared to the bag performance because of the tube behavior in the very early phase of the occupant body displacement, as shown in FIGS. 9 and 13-14. The tubes may not, and need not, inflate completely in order for the airbag 10 to be effective, and this can reduce some of the inflation volume required as well.

Inflation of each tubular structure is manageable in a number of ways. For example, the inflation gas may enter each tube individually, such that one fill tube can be directly connected to the inflator while the other structures are filled through this first tube. For example, as shown in FIGS. 3 and 4, the fill tube T may deliver inflation gas to a bag B, which is in fluid communication with the structures.

The size of the filling opening 50 on the structure and/or the fill tube may be designed to optimize and manage a desired filling sequence. For example, a bigger opening or a bigger tube is quicker to fill; a smaller opening or a smaller tube is slower to fill. In the embodiment where the tubular structures are provided in a stacked configuration, it may be desirable to first inflate the upper layer of structures, followed by inflation of the lower layer of structures. There may be one, two, more fill tubes T used.

A further benefit of the airbag system 10 is that if, for some reason, one of the openings 20 becomes clogged or unworkable or if one of the structures 12 becomes torn or otherwise damaged, there is at least one other tubular structure 12 connected thereto that can still be inflated and provide at least a portion of the desired cushioning effect.

In one particular embodiment, four tubular structures 12 may be sewn to one another along their length L in order to form a roughly rectangular airbag, as shown in FIG. 2. Each structure 12 generally has a similar structure, in that the length L (as well as the height H and the width W) of each of the tubular structures is about the same. In a particular embodiment, the length may be about 500-700 mm, and in particular embodiment, may be about 600 mm; the height may be about 300-400 mm, and in a particular embodiment, may be about 320 mm, and the width may be about 300-400 mm, and in a particular embodiment, may be about 320 mm. The height and width will generally be similar, but they need not be identical. In one example, air bag openings 50 may be collectively joined by a lower inflation bag B. As shown in FIG. 4, the inflation bag B may have slits 76 which allow introduction of the hose tube T inside the bag B. FIG. 4 also shows a line of stitching 78 along a centerline of each structure 12. This stitching 78 can help divide an upper layer into two distinct tubular structures 12, and a lower layer into two distinct tubular structures 12.

In another embodiment, the structures 12 may be secured to one another via a securing system 28. Securing system 28 may be formed of any appropriate means, including but not limited to one or more straps 30 configured to secure structures 12 to one another, stitching or sewing the structures 12 (e.g., stitching the upper layer 44 and the lower layer 46 to one another), using glue or tape or any other appropriate adhesive or bonding material to secure the structures 12 to one another, using a separate element to secure the structures 12 to one another, or any combination thereof. The general goal of securing system is to cause the airbag structures 12 to extend as a unit once inflated. It is preferable that the structures do not spread apart upon inflation, lest they not be effective at catching the vehicle occupant's forward momentum.

In the embodiment shown in FIG. 2, the securing system 28 is defined in part by two straps 30, which are secured to ends 32 of each structure 12. Straps 30 cause the structures 12 to extend outwardly (upon inflation) in a collective manner, such that the ends 32 stay close to one another upon airbag deployment, rather than splaying away from one another. The airbag of FIG. 2 also provides the top two structures 12A and 12B secured to one another via stitching along an internal seam 34 and the bottom two structures 12C and 12D secured to one another via stitching along an internal seam 36. The internal seams 34, 36 may be formed by stitching 78 illustrated by FIG. 4.

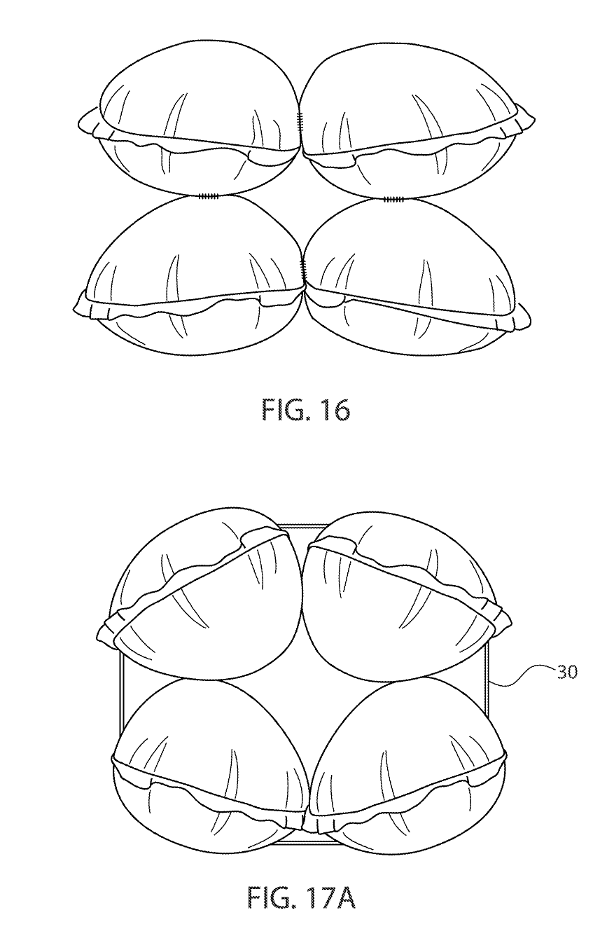

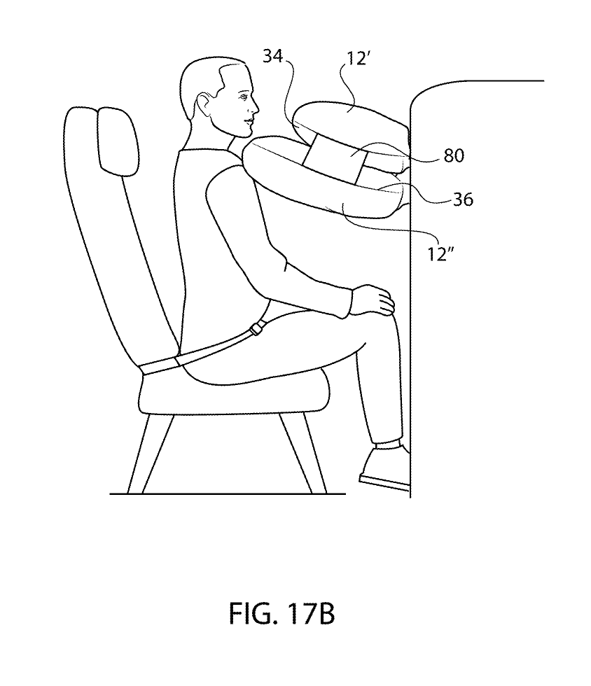

FIG. 16 shows an end view of a collection of tubular structures that are joined at a junction (where the top and bottom tubular structure contact one another) via stitching, adhesives, welding (such as high frequency welding) or any other appropriate method that links structures 12 together. FIG. 17A shows an end view of a collection of tubular structures that are joined via a lateral/side strap 80, avoiding the need for a junction point in the middle of the tubes. The strap 80 is shown as being a side-secured strap that generally encircles the tubular structures 12. It should be understood, however, that the strap may be positioned anywhere along the collection of structures. For example, a strap 30 may be secured at each of the back ends 32 (the (non-inflation ends) of the tubular structures 12, as illustrated by FIGS. 2-4 and 12.

FIG. 17B shows a side view of a lateral strap 80 that is positioned between two tubular structures in order to secure layers together. In this example, one end of the lateral strap 80 is stitched to one side seam 34 of a first tubular structure 12′, and another end of the lateral strap is stitched to a side seam 36 of a second tubular structure 12″. This example may use less material, which is generally desirable in an aircraft environment. It should also be understood that one or more lateral straps 80 may be positioned anywhere along the sides of one or more of the tubular structures 12.

The straps 30, 80 may be provided as a separate piece of material that is similar or different from the material of the tubular structures 12. In another example, the strap 30, 80 may be provided as an integral piece of the material forming the tubular structures 12. It should be understood that the tubular structures 12 may be secured in any number of ways, with a junction and a strap, with only a junction, or with only strap, or any combination thereof.

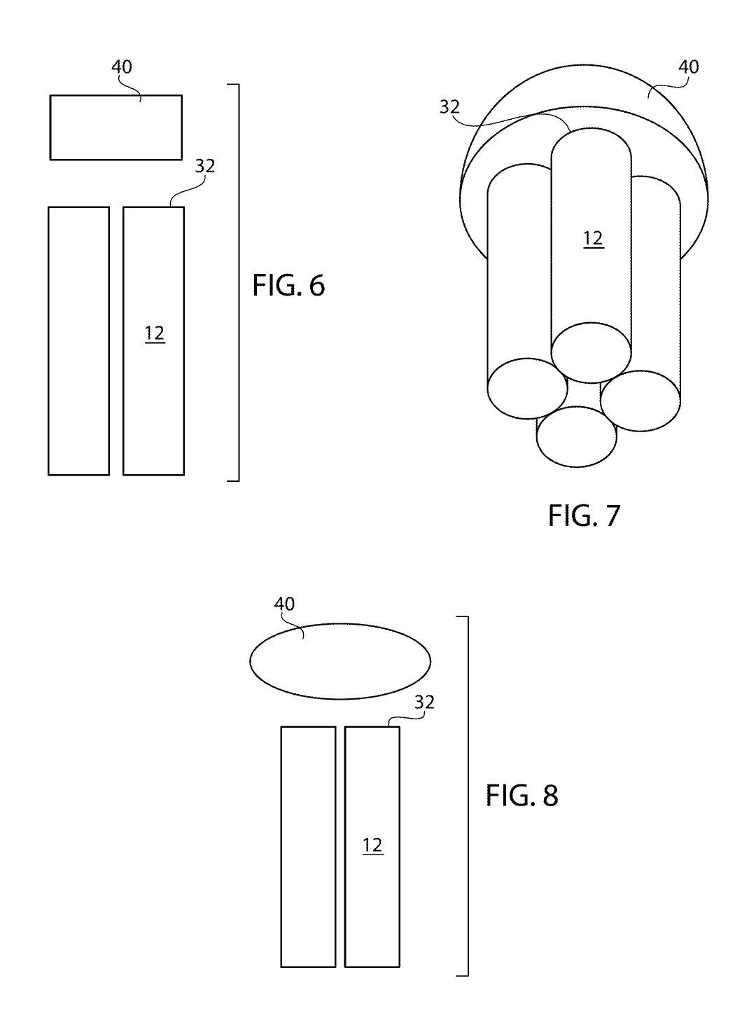

Another form of a securing system is shown in FIGS. 6-8. In these embodiments, the securing system is formed at least in part by a cushion 40. Cushion 40 is secured to ends 32 of tubular structures 12 as a way to (a) keep the ends 32 connected to one another but also to (b) provide a cushioned surface for cushioning the vehicle occupant's forward movement. Cushion 40 may be formed from the same or different material that forms tubular structures 12. One or more of the tubular structure ends 32 may be designed to fluidly communicate with cushion 40, such that inflation gas that enters structure 12 extends further into the cushion 40 so that cushion inflates simultaneously. Alternatively, cushion 40 may be provided with its own inflation tube, such that cushion is separately inflated. Cushion 40 may be provided in any appropriate shape, and is shown in FIG. 6 as having a square-like shape, in FIG. 7 as having a generally circular shape, and in FIG. 8 as having a generally crescent or oval shape. In another embodiment (not shown), cushion may be applied to overlay a top of two tubular structures (e.g., 12A and 12B) in order to form a top layer.

Referring now to FIGS. 3 and 4, an opening 50 of each structure 12 may have a tube T extending therefrom. Tube T is fluidly connected to opening 50 and further provides a fluid connection or link to a gas inflator system. Tube T may be any desired length or shape. It is generally a connection tube for inflation. In one example, one or more inflation tubes T may cooperate with one or more inflation structures 12. One or more different tubular structures 12 may be linked together, such that they share a common gas inflator system. Alternatively, multiple inflation tubes T may remain separate from one another and be connected separately to one or more gas inflator systems. Alternatively, as shown in FIG. 3, a single connection tube T may cooperate with a inflation bag B, which then delivers inflation gas to one or more inflation structures 12. Any appropriate sequence for inflating the tubular structures may be used, and may be dependent upon particular aircraft features and capabilities.

FIG. 9 illustrates a crash sequence showing the inflation of a tubular airbag 10 and how it braces a vehicle occupant's impact. Frame 9A shows one location where airbag 10 may be secured to a seat back, a privacy shall, a monument, or any other aircraft structure 42. It may be generally positioned at face or chest level. In this Frame, the passenger is sitting behind and offset from a monument M. In Frame 9B, a crash condition has been detected and the airbag system is in its deployment position. The airbag 10 may begin to deploy immediately upon detection of a crash condition, which is usually within (and often typically before) 100 ms of detection of the crash condition. (Any type of wiring, crash sensor system, and inflation system may be used to indicate that a crash condition has occurred and to cause the subsequent inflation of the airbag.) Frames 9C-E illustrate how the airbag system 10 prevents the passenger from hitting the aircraft structure 42 (which can be any vehicle component, such as a privacy shell, monument or seat back) in front of the passenger. In these Frames 9C-9E, the passenger's forward momentum is cushioned by the airbag. In FIG. 9F, the passenger begins moving rearwardly in the seat. The sequences may take in total between about 10 to 100 ms, depending of the gas flow of the inflator.

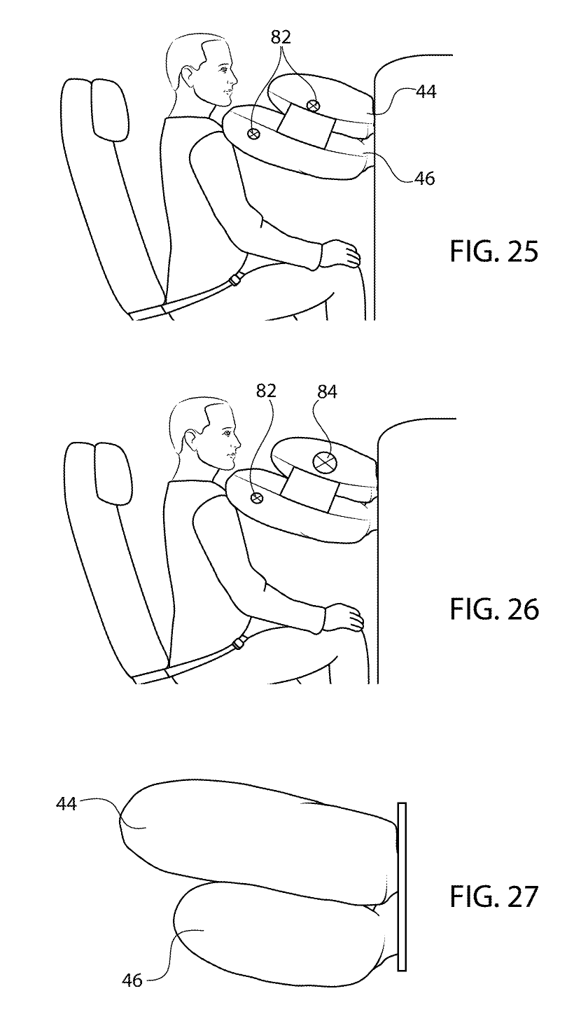

It is possible to provide one or more vents 82 on the tubular structures 12. The one or more vents 82 may function to manage the correct amortization and stopping of forward momentum of the passenger. In some cases, without a vent, there is no dissipation of energy and there can be a risk of higher injury to the passenger. After the airbag system 10 has cushion the passenger's impact, it is generally necessary for the tubular structures 12 of the system 10 to quickly deflate in order to allow passengers to evacuate the aircraft in an immediate manner. Accordingly, the vents 82 provided can allow the airbag to deflate after it has cushioned the passenger's impact. As shown by FIG. 25, it is possible for one or more vents 82 to be positioned on one or both of the tubular structures 12 of the upper layer 44. It is possible for one or more vents 84 to be positioned on one or both of the tubular structures 12 of the lower layer 46.

As is shown by FIG. 26, it is possible for the vents 82, 84 to have differing sizes. In one example, the vent 84 of the upper layer 44 may be larger than the vent 84 of the lower layer 46. Providing a larger vent may allow the tubular structure to deflate more quickly. Providing a smaller vent allows the tubular structure to maintain a higher pressure. This may help manage differential pressure between the tubular structures. In one example, because the upper layer 44 cushions impact of a passenger's head, it may be desirable for the upper layer to have one or more larger vents 84 as shown, so that it deflates more quickly than the lower layer.

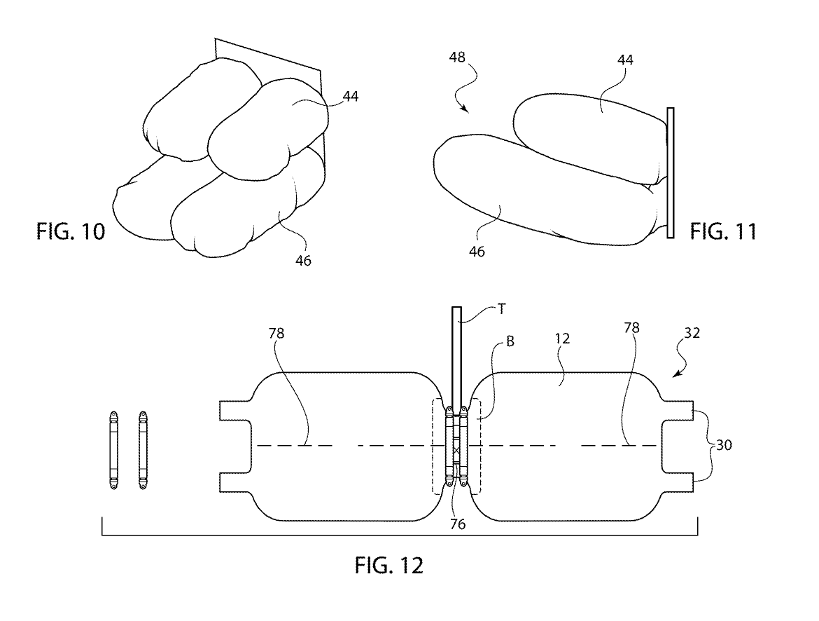

FIGS. 10-12 show an alternate embodiment of a tubular airbag having structures 12 of varied sizes. The structures 12 that form an upper layer 44 are slightly shorter in length than the structures 12 that form the lower layer 46. The intent and background of this design is to provide an indented area 48 that can help support a vehicle occupant's face more fully than if all structures are of equal length. In a specific embodiment, the upper layer of structures 12 is about ⅔ of the length of the lower layer 46 of structures 12. For example, the structures 12 of the upper layer 44 may have a length of about 400-500 mm, and in a particular embodiment, may be about 440 mm, and the structures 12 of the lower layer 46 may have a length of about 500-700 mm, and in particular embodiment, may be about 600 mm. FIG. 12 illustrates a cross-sectional view of the upper layer 44 of the airbag, before the tubular structures are stacked or otherwise secured. In another example, it is possible to provide the upper layer 44 as having a longer length than the lower layer 46, as illustrated by FIG. 27.

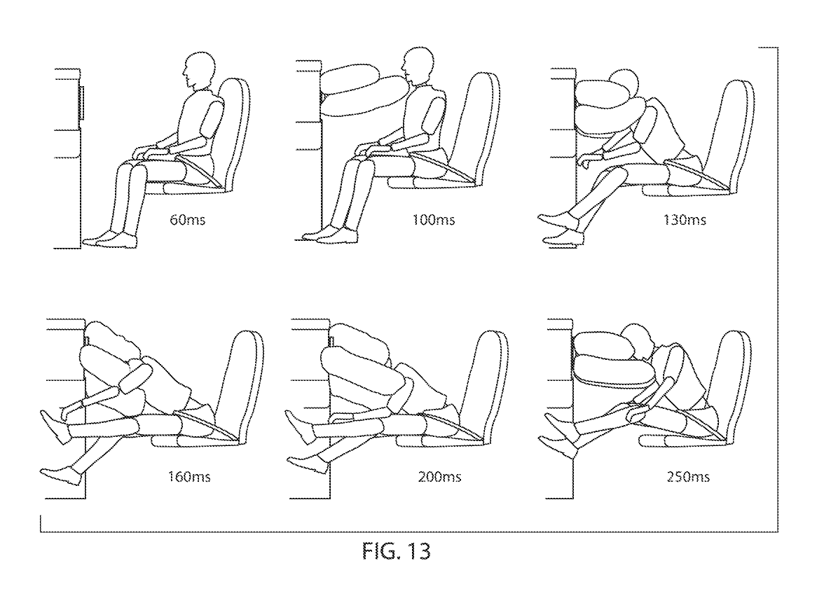

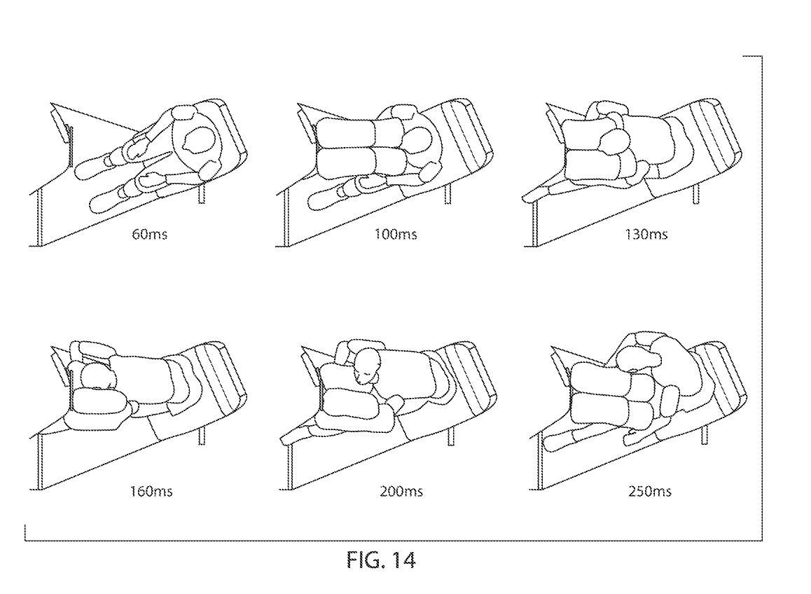

One example of a crash sequence showing this enhanced support is illustrated in FIGS. 13 and 14, which show a side and top view of a similar crash condition. The shortened structures are intended to protect the occupant's head at the end of its trajectory.

This embodiment uses even less gas for inflation of the airbag 10 because of the shortened length of the structure(s) positioned at upper layer 44. For example, a tubular airbag comprised of four tubular structures 12 (with the height and width remaining the same, but having varied lengths) is about 20-25% and by certain calculations, about 22% volume less to inflate than a traditional parallelepiped-shaped airbag. This saving in volume allows the use of a smaller inflator which gives a weight reduction of almost 18% in the gas inflator weight.

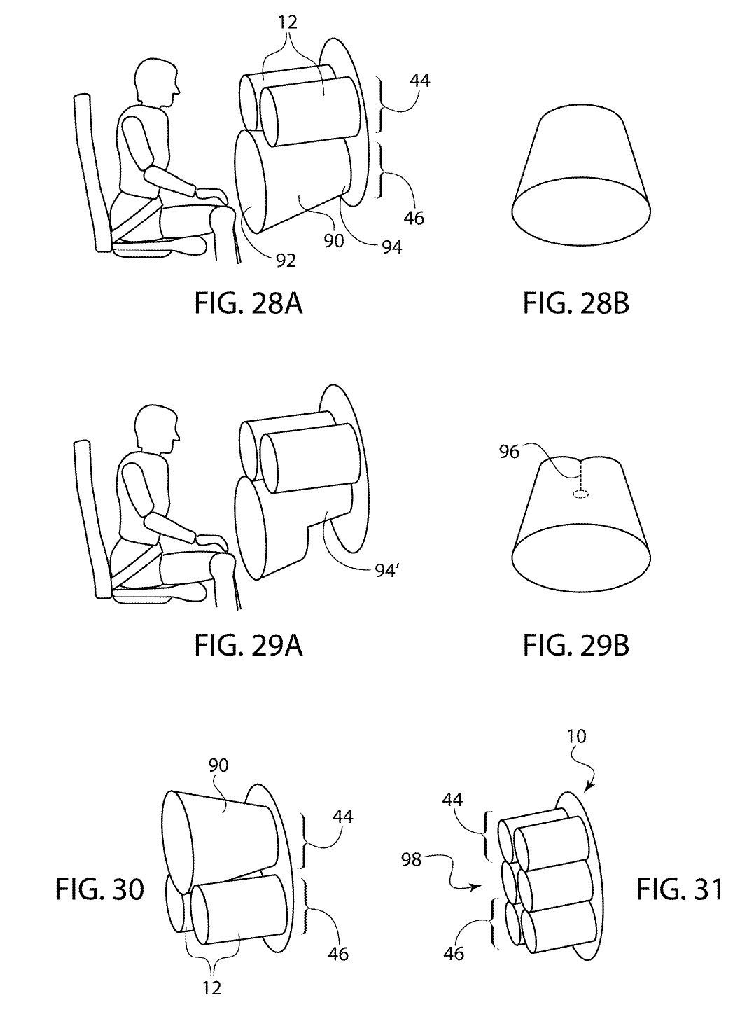

In other embodiments, it is possible to provide tubular structures 12 having varying sizes. For example, as shown in FIG. 28A, the upper layer 44 may be provided as two tubular structures 12 and the lower layer 46 may be provided as a single tubular structure 90. The single tubular structure 90 may have a generally oval or conical shape in either the horizontal or vertical dimension, as shown in FIGS. 28A and 28B. This may help increase surface area that is contact with a passenger's chest. In the embodiment shown, the passenger-facing portion 92 is generally more elongated than the monument connection portion 94, such that the structure 90 as a generally conical shape or cross-section. In another embodiment illustrated by FIG. 29A, the single tubular structure may be provided as having a modified conical shape, such that its passenger-facing portion is generally similar as described above. However, its monument connection portion 94′ may be provided as a more slender portion. It is believed that this embodiment can inflate similarly, while using less inflation gas. In either of these embodiments, it is possible to provide stitching 96 along at least a portion of the single tubular structure 90, which can further help lessen the inflation gas required, in either of these embodiments, it is possible for one or more fluid passageways to be provided between the tubular structures 12, 90. As shown in FIG. 30, it is also possible to switch the placement of the single tubular structure 90, so that it forms the upper layer 44.

In another example, it is possible to provide three or more layers 98 of inflatable tubular structures 12. FIG. 31 illustrates an airbag system 10 that includes an additional layer 98. In this example, there are three layers 44, 46, and 98 formed by three sets of dual/side-by-side tubular structures 12. It should be understood however, that more than three layers may be provided. For example, there may be four, five, six, seven, or even more layers of airbags provided if desired. It is also possible to provide a single, elongated tubular structure 90 that forms one or more of the layers 44, 46, or 98.

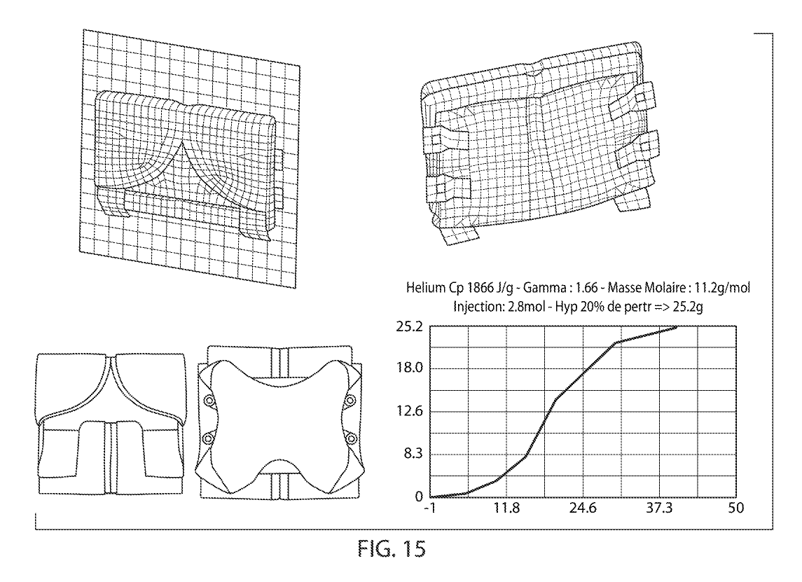

The tubular airbag system 10 described herein is easier to fold than traditional airbags, as the tubular structures 12 are designed to generally lay flat. This allows for an accurate folding and a lower package volume. The airbags are also able to be sewn with flat sewing seams, with junction of the tube structures by side tethers or straps. Examples of potential folding and sewing configurations are illustrated by FIGS. 15 and 18. As shown particularly by FIG. 18, once the tubular airbag is folded, it lays in a substantially flat manner and may be rolled up for stowage.

In order to manufacture the tubular airbag system 10, tubular structures 12 may be individually formed and secured to one another using any of the various securing systems 28 described herein. Alternatively, a top layer of material may be secured to a bottom layer of material with a seam extending the length thereof at the half way point, in order to create two side-by-side structures 12.

In use, the tubular airbag system is packed into a compartment or opening in a seat back, a privacy shell, a monument a steering wheel, or any other component in the vehicle from which an airbag may deploy. There is provided a system for attaching the tubular airbag system to an interior component of a vehicle. The attaching system may include one or more tubes T extending from an opening in each tubular structures which are intended to attach to an inflation source.

More specifically, the method for installing an airbag in a seat may include providing the tubular airbag system, including a system for securing the plurality of tubular structures to one another; providing a system for detecting a crash condition and causing the airbag to deploy; providing an inflation system for inflating the airbag; securing the airbag to the seat; securing the system for detecting a crash condition at a location that enables it to communicate with an activate the airbag upon a crash condition; and securing the system for inflating the airbag to the opening for receiving inflation gas.

Changes and modifications, additions and deletions may be made to the structures and methods recited above and shown in the drawings without departing from the scope or spirit of the invention and the following claims.

What is claimed is:

1. A tubular airbag system for use in a passenger transport vehicle, comprising:
(a) a plurality of inflatable tubular structures, each tubular structure having a length dimension that is greater than its width or height dimension, and comprising an opening at its end for receiving inflation gas; the plurality of inflatable tubular structures comprising a first level comprising first and second side-by-side inflatable structures and a second level comprising a single inflatable structure having a conical cross section; and
(b) a system for securing the plurality of tubular structures to one another such that they deploy together.

2. The tubular airbag system of claim 1, further comprising a system for delivering inflation gas to the tubular airbag system.

3. The tubular airbag system of claim 1, wherein the system for securing the plurality of airbags to one another comprises a strap.

4. The tubular airbag system of claim 1, further comprising a system for attaching the tubular airbag system to an interior component of a vehicle.

5. The tubular airbag system of claim 4, wherein the system for attaching the tubular airbag system to an interior component of a vehicle comprises an inflation bag in fluid communication with one or more tubes extending from the inflation bag, wherein the one or tubes are in fluid communication with an inflation source.

6. The tubular airbag system of claim 1, further comprising a source of inflation gas in fluid communication with each tubular structure.

7. The tubular airbag system of claim 1, installed on a seat back of an aircraft seat, an aircraft monument, or an aircraft privacy shell.

8. The tubular airbag system of claim 1, installed in front of an aircraft seat at a securement location.

9. The tubular airbag system of claim 8, wherein a connection face of at least one of the inflatable structures comprises an angled connection face configured to compensate for an angle occurring between the securement location and the aircraft seat.

10. The tubular airbag system of claim 1, wherein the first and second side-by-side inflatable structures are in fluid communication with one another via a fluid passageway.

11. A tubular airbag system for use in a passenger transport vehicle, comprising:
(a) a plurality of inflatable tubular structures, each tubular structure having a length dimension that is greater than its width or height dimension, and comprising an opening at its end for receiving inflation gas, each opening being in fluid communication with an inflation bag;
(b) wherein at least one of the inflation bag or the plurality of inflatable tubular structures comprise an angled connection face configured to be secured to a securement location in front of a passenger seat, wherein the angled connection face compensates for an angle occurring between the securement location and the passenger seat located therebehind.

12. The tubular airbag system of claim 11, further comprising a system for delivering inflation gas to the tubular airbag system.

13. The tubular airbag system of claim 11, further comprising a system for securing the plurality of airbags to one another comprising a strap.

14. The tubular airbag system of claim 11, further comprising a system for attaching the tubular airbag system to an interior component of a vehicle.

15. The tubular airbag system of claim 14, wherein the system for attaching the tubular airbag system to an interior component of a vehicle comprises an inflation bag in fluid communication with one or more tubes extending from the inflation bag, wherein the one or tubes are in fluid communication with an inflation source.

16. The tubular airbag system of claim 11, further comprising a source of inflation gas in fluid communication with each tubular structure.

17. The tubular airbag system of claim 11, installed on a seat back of an aircraft seat, an aircraft monument, or an aircraft privacy shell.

18. The tubular airbag system of claim 11, wherein the first and second side-by-side inflatable structures are in fluid communication with one another via a fluid passageway.

19. A tubular airbag system for use in a passenger transport vehicle, comprising:
(a) a plurality of inflatable tubular structures, each tubular structure having a length dimension that is greater than its width or height dimension, and comprising an opening at its end for receiving inflation gas;
(b) at least one fluid passageway along the length dimension of one or more of the plurality of inflatable tubular structures, allowing fluid communication therebetween.

20. The tubular airbag system of claim 19, further comprising a system for delivering inflation gas to the tubular airbag system.

21. The tubular airbag system of claim 19, further comprising a system for securing the plurality of airbags to one another comprising a strap.

22. The tubular airbag system of claim 19, further comprising a system for attaching the tubular airbag system to an interior component of a vehicle.

23. The tubular airbag system of claim 22, wherein the system for attaching the tubular airbag system to an interior component of a vehicle comprises an inflation bag in fluid communication with one or more tubes extending from the inflation bag, wherein the one or tubes are in fluid communication with an inflation source.

24. The tubular airbag system of claim 19, further comprising a source of inflation gas in fluid communication with each tubular structure.

25. The tubular airbag system of claim 19, installed on a seat back of an aircraft seat, an aircraft monument, or an aircraft privacy shell.

26. The tubular airbag system of claim 1, installed in front of an aircraft seat at a securement location.

27. The tubular airbag system of claim 26, wherein a connection face of at least one of the inflatable structures comprises an angled connection face configured to compensate for an angle occurring between the securement location and the aircraft seat.
